(19) United States
(12) Patent Application Publication
(10) Pub. No.: US 2005/0283340 A1
(43) Pub. Date: Dec. 22, 2005

(54) Method and apparatus for configuring power-up sequences

(76) Inventors: Akshay Mathur, Maple Shade, NJ (US); Anton Bodner, Turnesville, NJ (US)

Correspondence Address: BECK AND TYSVER P.L.L.C., 2900 THOMAS AVENUE SOUTH, SUITE 100, MINNEAPOLIS, MN, 55416, US

(21) Appl. No.: 10/873,371

(22) Filed: Jun. 21, 2004

(51) Int. Cl. G06F 11/30; G06F 15/00; G21C 17/00

(52) U.S. Cl. 702/183

(57) ABSTRACT

A system and method is presented for defining power-up sequences and menus through a macro file. The macro file is compiled into a data construct that is stored on a computing device. On the powering up of the computing device, a first algorithm reads and executes a series of diagnostic tests from the stored data construct. On the failure of a critical diagnostic test, a second algorithm reads and presents a menu structure found in the stored data construct. The data construct can be recompiled and re-stored on the computing device so as to alter the power-up sequence and the menu structure without altering the first or second algorithm.

### FIELD OF THE INVENTION

The invention relates to system initialization. More particularly, the present invention relates to configuring and executing a specified sequence of self-tests upon power-up a computer device.

### BACKGROUND OF THE INVENTION

Many computer systems require that a particular sequence of routines or self-tests be performed when the system is initially powered on. This sequence generally performs a number of system and software checks before an operating system is loaded. By checking the system, the sequence ensures that the computer system is able to operate in the manner intended. For example, the sequence might run a battery check, a peripheral check, and any other series of self-tests or diagnostic routines.

These power-up sequences are often associated with a menu system that gave a user access to self-test procedures and the related logs and results. A power-on sequence might be programmed to initiate the menu on the failure of any of the test. The menu would then allow the user to re-run the self-tests that formed part of the power-on sequence, execute additional self-tests, or view detailed logs or results from the tests. This menu is generally operable before loading the user interface of the device's operating system. The menu system may also be initiated on device start-up through user action, such as by having the user set a dipswitch, attach a jumper, or hold down a key or button during power-up. In addition, some devices may wish to make this menu available through the operating system after the device has successfully completed its power-on cycle.

In prior art devices, these power-up sequences and menu structures had to be separately defined and hard coded for each type of device. The lack of portability between devices has slowed the development of power-up sequences and self-test menus. Furthermore, prior art power-up sequences and menu structures tended to take up significant room in the program storage available in the device. Finally, the prior art practice of hard coding the power-up sequences and menus has made it difficult to change either the sequences or menus after their initial development. What is needed is a method for defining and implementing power-up sequences and menu structures that is easily portable, takes a minimum of storage space, and is easily changeable after initial development.

### SUMMARY OF THE INVENTION

These needs are met in the present invention technique of defining power-up sequences and menus through a macro language. The macro language includes only a few keywords. The keywords define the basic elements needed to construct a menu structure and sequence of self-tests to be performed on system start-up. The keywords are combined into macros that specify the items on particular menus and submenus. The power-up sequence of tests can be defined separately from the menu structure, or as a specially designated submenu in the menu structure.

The actual self-tests are defined outside the keywords and macros that make up the present invention. These routines are incorporated into the present invention through an ATEST keyword. This keyword takes parameters that define the function to be performed, whether the test is of a critical nature, the number of times the test should be repeated, and the way in which the test should be displayed in the menu structure.

The macros are then compiled into a high-level language data construct, such as C++ objects. Two small, efficient algorithms then operate upon these data constructs. The first algorithm simply executes the routines specified in the macros to be executed on power-up. The routines are executed in order, with errors being logged. The second algorithm is responsible for presenting to the user the menu structure defined in the macro. This second algorithm requires only the ability to print a character to a user and receive a character input from a user, and therefore does not require the entire user interface capabilities that are built into an operating system. Consequently, the second algorithm is able to operate on a computing device even before the operating system is loaded.

### BRIEF DESCRIPTION OF THE DRAWINGS

FIG. 1 is a schematic diagram showing the major elements of the present invention.

FIG. 2 is a table showing the keywords and related parameters used by the macro language of the present invention.

FIG. 3 is a sample macro definition file.

FIG. 4 is a flow chart showing the steps in the Power-On Self-Test algorithm of the present invention.

FIG. 5 is a flow chart showing the steps in the menu algorithm of the present invention.

### DETAILED DESCRIPTION OF THE INVENTION

Overview

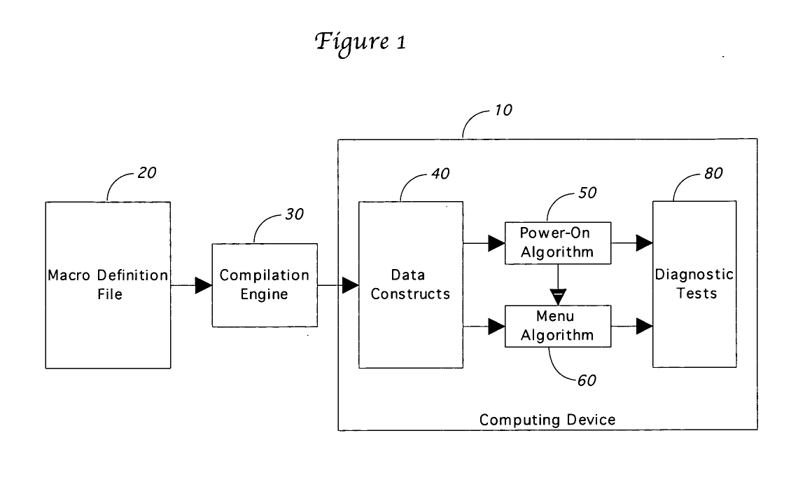

FIG. 1 shows the major components and data/process flow of the present invention technique for defining and implementing power-up sequences and menus on one or more computing devices 10. The term computing device should be understood to mean any electronic device having a processor or other intelligence capable of executing compiled computer instructions. The term computer device can include, without limitation, an actual mainframe, mini, or microcomputer; a network device such as a hub, bridge, router, or network interface card; or a storage related device such a switch, controller, or storage device.

Element 20 in FIG. 1 is a macro language definition file that is generated by a user as a text file. The user creates this file to define the series of tests that will be executed when the computing device 10 is powered on, as well as to define the desired test menu structure for that computing device.

A macro translator, or compilation engine 30, reads the macros in definition file 20 and compiles them into one or more compiled data constructs 40. Any commercially available compiler can function as the compilation engine 30, including XX. The resulting data constructs 40 are of a type that can be read and understood by compiled software code on the computing device. In this case, the compiled software code consists of two algorithms, a power-up algorithm 50 and a menu algorithm 60. Each of these algorithms is extremely small and efficient. They can be written in assembly language, or be compiled from a higher-level language using a compiler such as compilation engine 30.

The power-on self-test (or “POST”) algorithm 50 serves to read one or more of the data constructs 40 to determine the diagnostic tests 80 that should be initiated during the computing devices power-on cycle. The power-on algorithm 50 launches the tests 80 in the order specified by the data constructs 40. The macro definition file 20 and the resulting data constructs 40 may instruct the algorithm 50 to repeat certain tests 80 during the power-up cycle, and may specify that some test 80 are critical tests. The power-up algorithm 50 will operate until all of the tests 80 specified in the data constructs 40 are operated, or until a critical test has failed. In the preferred embodiment, the failure of a critical test will cause the power-up algorithm to cease operating, and will initiate the menu algorithm 60. Alternatively, the failure of a critical test could cause power-up to cease with an error message being sent to the user.

The menu algorithm 60 presents a menu interface to the user based upon the menu definitions in the data constructs 40. This menu may have submenus, and will allow users to traverse the menu structure and individually select a diagnostic test 80 to operate. The menu will also allow users to examine outputs and logs from the diagnostic tests 80, and to exit the menu algorithm 60 when desired. Whether or not the computer device 10 continues powering up upon exiting the menu structure will depend on the ability of the device 10 to pass critical diagnostic tests and upon the choices implemented by the device manufacturer.

Macro Keywords

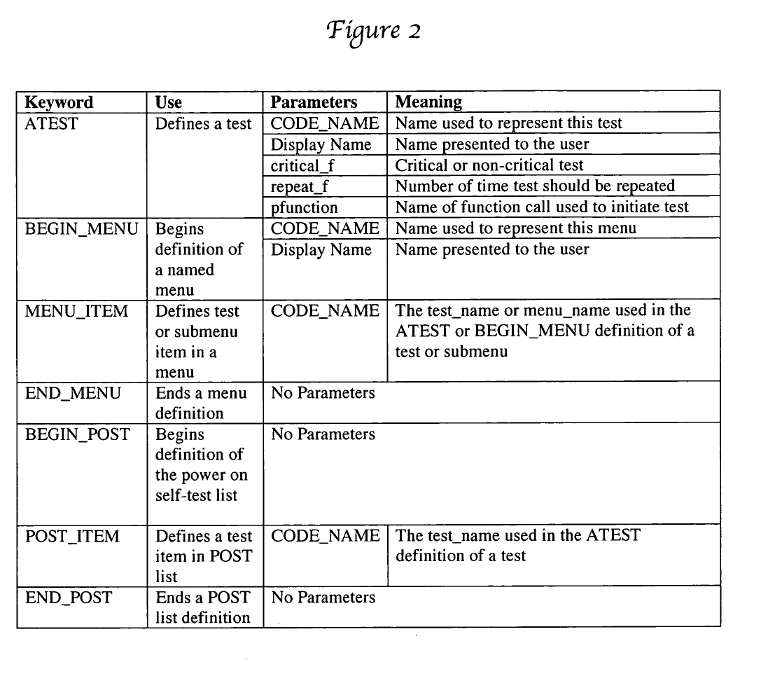

The macro definition file 20 that defines the data constructs 40 uses a set of easy to understand keywords. The keywords used in the preferred embodiment of the present invention are found in the table of FIG. 2 and are described below. The present invention, however, is not limited to these specific keywords. Those of ordinary skill could develop many variations in the terminology and logical meanings of these keywords without departing from the spirit and scope of the present invention.

The ATEST keyword is used to define a test in the macro definition file 20. The test 80 itself is already found within the computing device 10 in a compiled, ready-to execute format. It is assumed that this test can be executed within the computing device 10 by making the appropriate function call. The ATEST keyword serves to define that test within macro language used by the macro definition file 20. In a first embodiment, the ATEST keyword has five parameters. The first parameter, CODE_NAME, is used to define the name that will be used by other elements of the macro definition file 20 to identify this test. In the preferred embodiment, the parameter is a string representing the code-like name, and does not contain spaces or other non-lexical characters.

The Display Name parameter defines the name that appears in the menu interface to the user. In this way, the user can see a longer, more descriptive name for the test 80 rather than the internal macro level name (CODE_NAME) or the actual function call that calls the test 80.

The next two parameters are flags that determine whether the test 80 being defined is considered a critical test (critical_f) or whether the test 80 should repeat a given number of times (repeat_f). While the critical flag is a true binary flag, the repeat flag is a numerical value. If the repeat flag is set to 0, the test will run once and not repeat. If the repeat flag is set to some non-zero number, the test will repeat the number of times indicated by this value. In an alternative embodiment, the TEST keyword does not have either flag. In this embodiment, all tests are considered critical, and all tests repeat the same number of times.

Finally, the pfunction parameter defines the actual function call that is used to initiate the test 80 on the computing device 10. When either the power-up algorithm 50 or the menu algorithm 60 wishes to execute a self-test 80, this parameter value will be used to actually execute the test.

The above description indicates that a single diagnostic test 80 is normally associated an ATEST keyword. While this is the preferred embodiment, it would be well within the scope of the present invention to associate multiple diagnostic tests 80 within a signal ATEST definition. One way to accomplish this would be to allow the pfunction parameter to contain a list of associated function calls to the tests 80.

The BEGIN_MENU keyword beings the definition of a named menu, while the END_MENU keyword ends the definition. Between these two keywords all that is allowed is one or more MENU_ITEM keywords, which define the items on this particular menu.

The BEGIN_MENU keyword has two parameters, CODE_NAME and Display Name. The CODE_NAME parameter is the name of the menu as will be used by other menus to call this menu as a submenu. Like the CODE_NAME parameter in the ATEST keyword, the BEGIN_MENU CODE_NAME parameter can have no spaces or other non-lexical characters. The Display Name is the user-friendly version of the code name for presentation to the user. The Display Name parameter is allowed to have spaces. The END_MENU keyword has no parameters, since it merely indicates the end of a menu definition. The MENU_ITEM keyword has only a single parameter, namely CODE_NAME. This parameter contains the CODE_NAME of a test defined by an ATEST keyword, or contains a CODE_NAME of a submenu. Since the menu algorithm 60 will obviously respond differently if the MENU_ITEM contains a test rather than a submenu, one alternative embodiment would be to separate the MENU_ITEM keyword into two separate keywords. More particularly, the MENU_ITEM keyword could be replaced with a MENU_TEST_ITEM keyword to identify tests, and a MENU_SUB_ITEM keyword to identify sub menus.

The BEGIN_POST, POST_ITEM, and END_POST keyword are very similar to the BEGIN_MENU, MENU_ITEM, and END_MENU keywords, except that the post related keywords define the power-on self-test list as opposed to a menu. This list indicates the tests 80 (defined by the ATEST keyword) that are to be executed every time the computing device 10 is powered on. The macro definition file 20 will preferably define only a single post list, and therefore there is no need to name a post list. Hence, there are no parameters to the BEGIN_POST keyword. The POST_ITEM keyword contains a single parameter, CODE_NAME, which contains the CODE_NAME of a test defined by an ATEST keyword.

Alternatively, it would be possible to define the POST list without these keywords by defining a submenu with the desired tests 80 and naming this submenu “POST” or other pre-defined name. The power-on algorithm 50 would then search the data constructs 40 for the appropriately named submenu to identify the diagnostic tests 80 for power-on. This alternative method is often preferred, as it combines the menu and POST list definitions, which simplifies the macro definition file 20 by eliminating the BEGIN_POST, POST_ITEM, and END_POST keywords. This also simplifies the resulting data constructs 40 as well.

Example Macro Definition File

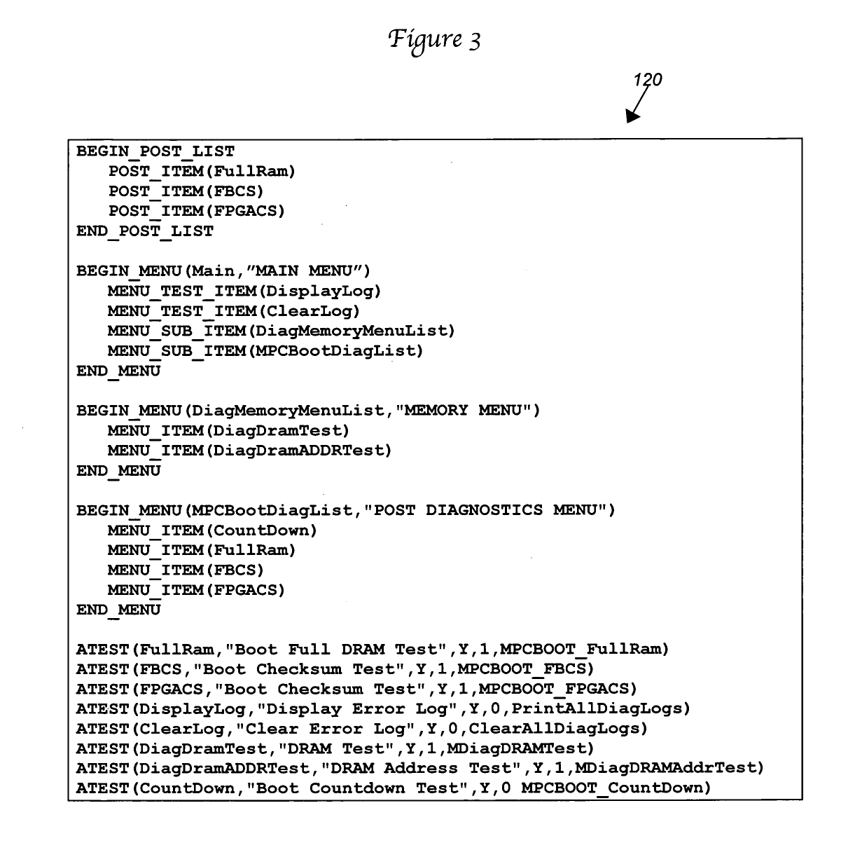

FIG. 3 shows an example macro definition file 120. In this file 120, the power-on self-test list consists of three diagnostic tests, namely FullRam, FBCS, and FPGACS. These three tests are defined more fully through three separate ATEST statements at the bottom of the macro definition file 120. As can be seen in the ATEST statements, each of these three tests calls a particular test function, namely MPCBOOT_FullRAM, MPCBOOT_FBCS, and MPCBOOT_FPGACS, respectively. All of these tests are critical tests (hence the “Y” in the third parameter) and each will repeat one time (indicated by the “1” in the fourth parameter). In the alternative embodiment that does not contain these flags, the third and fourth parameters would simply not appear in this file 120.

The macro definition file 120 in FIG. 3 also defines a menu structure containing a main menu, and two submenus. The main menu contains two separate tests, namely DisplayLog and ClearLog, as well as entries for the two submenus. The Memory Menu submenu contains only two tests, while the Post Diagnostics Menu contains four tests. All of these tests are defined in separate ATEST statements in file 120.

The compilation engine 30 takes the macro definition file 20 and converts it to compiled data constructs 40 that can be stored on the computing device 10. The actual format of the data constructs 40 can vary significantly, depending on the processor used by the computer device 10, the compiled formats of the power-on algorithm 50 and menu algorithms 60, and the format of the self-tests 80 found on the computing device 10.

The Power-On Self-Test Algorithm

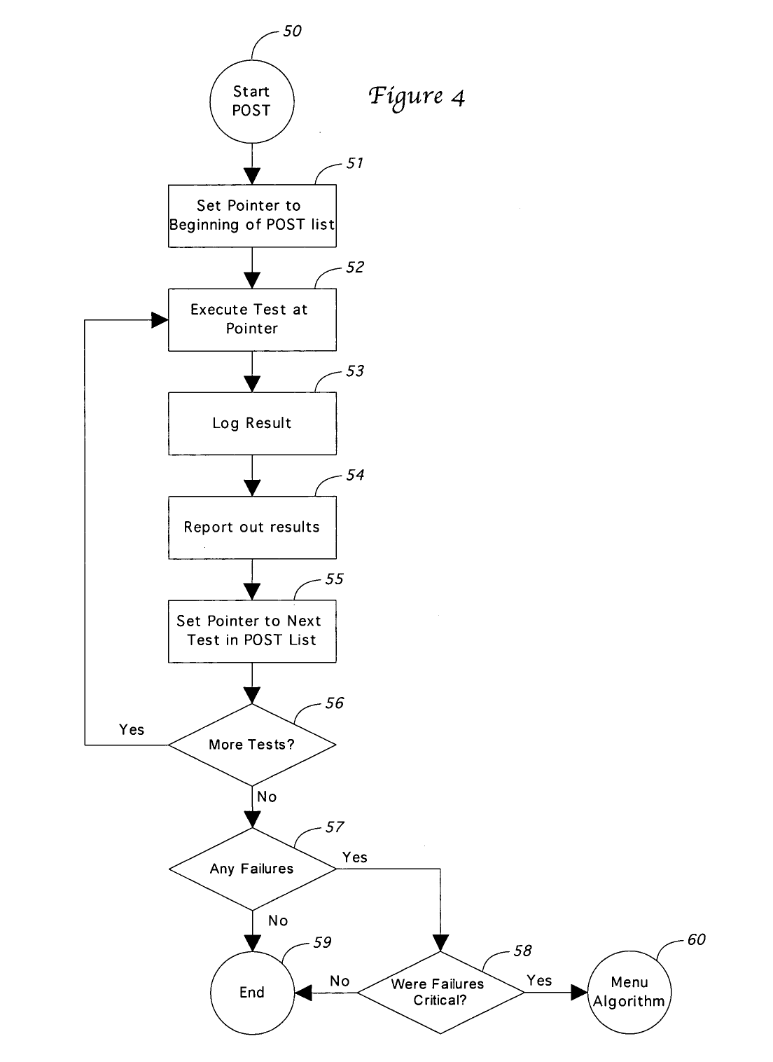

The power-on self-test algorithm 50 is presented in flow chart form in FIG. 4. The algorithm starts with the initialization of a pointer to the first test 80 on the POST list at step 51. The pointer could be an index to an array of tests defined as the POST list, or some other indicator to select a particular item on a list. The selected test 80 is executed at step 52, and the results are logged in step 53 and reported out to a user in step 54. In step 55, the pointer is updated to the next test in the POST list. Step 56 determines if there is a valid test at the pointer (i.e., if there are any more tests in the POST list). If so, execution returns to step 52 with the next test 80 being executed. If step 56 determines that there are no more tests 80 to be executed in the POST list, step 57 determines if any of the tests returned a failure condition. If not, the POST algorithm 50 ends at step 59. If one or more tests do fail, step 58 determines whether the failed tests were critical tests (as determined by the critical_f flag in the ATEST definition of the test). If the failed test was not critical, then the power-on self-test routine 50 ends at step 59. If a critical test did fail, the menu algorithm 60 is initiated. The automatic triggering of the menu algorithm 60 upon the failure of a critical self-test is one of many possible implementations within the scope of the present invention. For instance, a device developer may choose to initiate the menu algorithm 60 on any test failure, or to initiate the menu algorithm 60 only at the election of the user.

In the alternative embodiment where all tests are considered critical, the failure of any test would initiate the menu algorithm 60. In addition, the power-on self-test algorithm 50 could be programmed to stop all tests immediately on the failure of any test. In this alternative, each test would be examined for failure after step 52. If the test fails, the loop would terminate and the POST algorithm 50 would terminate.

The Menu Algorithm

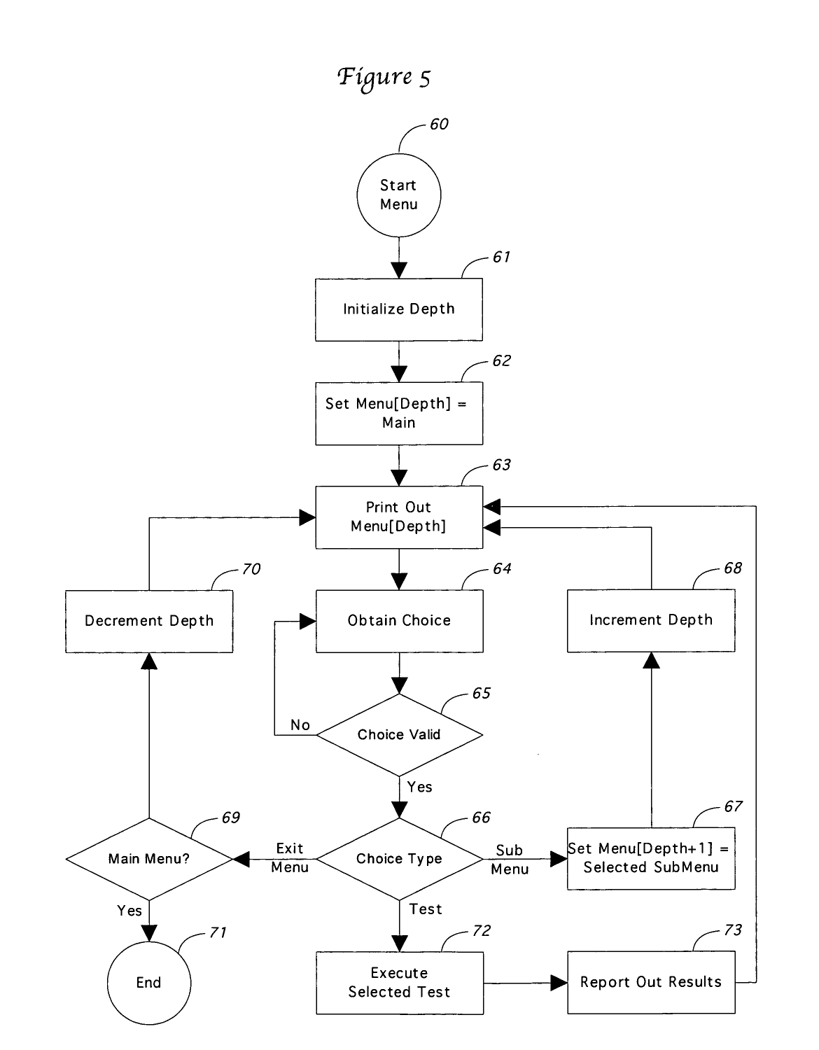

The menu algorithm 60 is presented in flow chart form in FIG. 5. This algorithm 60 provides a mechanism for traversing menus and submenus while using little stack space. This is achieved by maintaining a menu traversal history. In the embodiment shown in FIG. 5, this traversal history is maintained through the use of an index called “depth” which tracks the current submenu depth being displayed. This value is then used to index a dynamically maintained array of menus and submenus. To accomplish this, the first step 61 in menu algorithm 60 initializes the depth value, such as to a value of zero. Step 62 then assigns the menu array at that initial depth to be the main menu defined in the data constructs 40. The main menu can be identified by a particular menu name, such as “main.” Alternatively, the main menu can be identified through the use of dedicated macro keywords, such as by using a “BEGIN_MAIN_MENU” keyword instead of the BEGIN_MENU keyword.

Once the menu array at the top level of the hierarchy has been defined, the algorithm begins displaying the menu tree. Step 63 prints out the menu items for the current menu. The current menu is pointed to by the menu array at the current depth. By “printing out” the menu, the preferred embodiment merely outputs the menu character by character through a rudimentary writeCharacter( ) method.

At step 64, the menu algorithm accepts a user input in response to the menu. This is preferably accomplished through a simple readCharacter( ) method. Step 65 then validates that the user input is a valid response to this particular method. To accomplish this, the algorithm 60 must have knowledge about the appropriate response ranges for each menu. This is accomplished simply by counting the number of MENU_ITEMS in the menu during the printing out of the menu in step 63. If step 65 determines that the user input is invalid, the algorithm returns to step 64 to await a valid input.

If the input is valid, step 66 examines the user selected menu item and determines whether the selected item is a request to leave a menu, access a submenu, or to perform a task. The indication to leave a submenu need not be a separately defined option using a MENU_ITEM keyword. Rather, the user can simply be instructed to use a special character (such as ESCAPE) to leave the menu.

If step 66 determines that the user selected to access a submenu, it is necessary to add the selected menu to the next level of the menu array, which is accomplished in Step 67. Step 68 then increments the depth level, and the selected submenu is printed out in step 63.

If step 66 determines that the user wishes to leave the current menu, then step 69 determines if the user is already at the top of the menu hierarchy. If not, the depth level is decremented by one at step 70, and the next highest level of the menu hierarchy is printed out at step 63. If the user desires to exit the main menu (the top menu in the hierarchy), the menu algorithm 60 ends at step 71. What occurs next in the power-up process is then up to the device manufacturer. The power-up could continue, or, if a critical self-test failed, the computing device 10 could simply shut down. One could also design the menu algorithm 60 to run indefinitely, and simply not allow the user to exit from the main or top menu in the hierarchy.

If step 66 determines that a test was selected, then the desired test is executed at step 72. The results of the test are presented to the user in step 73, and the menu algorithm resumes at the same menu level at step 63.

Benefits

By using the present invention, the definition of the start-up diagnostic test sequence and the related menu structure is separated from the algorithms that perform the start up sequence or present the menu structure. By separating the definitions from the algorithms, the definitions can be created by an individual with little or no programming skill. Furthermore, the fact that the compiled data structures remain separate from the algorithms means that these data structures may be replaced and updated at any time without altering the algorithms themselves. This greatly simplifies the effort required to update either of these elements.

This invention also leads to a decrease in the amount of effort necessary to develop power-up sequences and related menu structures for new computing devices. Because the actual algorithms are of such a simple design, they can easily be recompiled and reused on a great variety of computing devices without any additional programming. The individualization that is necessary for each separate type of computing device is isolated in the macro definition file and the resulting data constructs.

The present invention is not to be limited to all of the above details, as modifications and variations may be made without departing from the intent or scope of the invention. Those skilled in the art will appreciate that the basic conception of this invention may be utilized for designing future electronic products including new communication devices and switches. Consequently, the invention should not be limited by the specifics of the above description, but rather be limited only by the following claims and equivalent constructions.

1. A method for executing a power-on self-test sequence of diagnostic tests on a computing device comprising:
a) creating a macro definition file having
i) a plurality of test definitions, each test definition including instructions on how to execute an associated diagnostic test; and
ii) a list of selected test definitions to be performed by the computing device during power-on;
b) compiling the macro definition file into at least one compiled data construct;
c) storing the at least one compiled data construct on the computing device; and
d) executing on the computing device a power-on self-test algorithm that is separate from the compiled data construct, with the power-on self-test algorithm operating by
i) obtaining the list of selected test definitions from the compiled data construct on the computing device; and
ii) executing each of the selected test definitions from the list.

2. The method of claim 1, wherein the diagnostic tests are executed via function calls, and the instructions on how to execute a diagnostic test constitute the appropriate function call.

3. The method of claim 2, wherein the selected test definitions are executed by executing the function calls of the diagnostic tests associated with the test definitions.

4. The method of claim 1, wherein a plurality of diagnostic tests are associated with at least one of the test definitions.

5. The method of claim 1, wherein each test definition further includes an indication as to whether the associated diagnostic test is a critical test.

6. The method of claim 5, wherein the power-on self-test algorithm receives the results of each executed test definition, and further wherein the self-test algorithm determines if a critical test has failed.

7. The method of claim 6, wherein the macro definition file has a menu definition, and further comprising executing a menu algorithm on the computing device if the self-test algorithm determines that a critical test has failed, wherein the menu algorithm reads the menu definition from the compiled data construct.

8. The method of claim 1, wherein the macro definition file is a text file.

9. A method for executing a power-on self-test sequence of diagnostic tests on a computing device comprising:
a) creating a macro definition file having
i) a plurality of test definitions, each test definition including instructions on how to execute an associated diagnostic test,
ii) a list of selected test definitions to be performed by the computing device during power-on, and
iii) a menu definition consisting of a list of menu items;
b) compiling the macro definition file into at least one compiled data construct;
c) storing the at least one compiled data construct on the computing device;
d) executing on the computing device a power-on self-test algorithm that is separate from the compiled data construct, with the power-on self-test algorithm operating by
i) obtaining the list of selected test definitions from the compiled data construct on the computing device; and
ii) executing in turn each of the selected test definitions from the list; and
e) executing on the computing device a menu algorithm that is separate from the compiled data construct, with the menu algorithm operating by:
i) obtaining the menu definition from the compiled data construct,
ii) outputting each of the menu items to a user,
iii) obtaining a user selection corresponding to a menu item, and
iv) executing the corresponding menu item.

10. The method of claim 9, wherein
i) each test definition further includes an indication as to whether the associated diagnostic test is a critical test,
ii) the power-on self-test algorithm receives the results of each executed test definition,
iii) the self-test algorithm determines if a critical test has failed, and
iv) the menu algorithm is executed after the self-test algorithm determines that a critical test has failed.

11. A system for creating and executing a power-on self-test sequence of diagnostic tests on a computing device comprising:
a) a file containing
i) a means for defining a plurality of test definitions including instructions on how to execute an associated diagnostic test,
ii) a means for selecting particular test definitions to be performed during power-on, and
b) a data construct compiled from the file, the data construct being stored on the computing device; and
c) means for performing the particular test definitions during power-on.

12. The system of claim 11, wherein the file further contains a means for defining a menu structure.

13. The system of claim 12, further comprising:
d) means for operatively presenting the menu structure to an end user to allow the user to select and execute menu options.

14. A system for creating and executing a power-on self-test sequence of diagnostic tests on a computing device comprising:
a) a macro file containing
i) a plurality of test definitions including instructions on how to execute an associated diagnostic test,
ii) a sequence of test definitions to be performed during power-on, and
b) a data construct compiled from the file, the data construct being stored on the computing device; and
c) an algorithm that executes the sequence of test definitions during power-on.
